(19) United States
(12) Patent Application Publication
(10) Pub. No.: US 2026/0156213 A1
(43) Pub. Date: Jun. 4, 2026

(54) PROVIDING USER SUPPORT DURING VOICE CALLS VIA GENERATIVE ARTIFICIAL INTELLIGENCE

(71) Applicant: AT&T Intellectual Property I, L.P., Atlanta, GA (US)

(72) Inventors: Yuan Ding, Plainsboro, NJ (US); Michael Chin, Clinton, NJ (US); Joseph Dahan, Redmond, WA (US); Vinay Sharma, Levittown, NY (US)

(21) Appl. No.: 18/967,629

(22) Filed: Dec. 3, 2024

(51) Int. Cl. H04M 3/22; G10L 15/22

(52) U.S. Cl. CPC H04M 3/2218; G10L 15/22; G10L 2015/223

(57) ABSTRACT

Devices, non-transitory computer-readable media, and methods for providing user support during voice calls via generative artificial intelligence are disclosed. An example method includes receiving, from a user endpoint device, a request to monitor an ongoing voice call between the user endpoint device and a second device for at least one task with which a generative artificial intelligence assistant is able to assist, monitoring the voice call in response to the request, detecting, based on the monitoring, a task to be performed on behalf of a user of the user endpoint device, executing the generative artificial intelligence assistant to generate an output in connection with the task, converting the output to an audio output using the generative artificial intelligence assistant, and delivering the audio output to the user endpoint device during the voice call.

The present disclosure relates generally to wireless communications, and relates more particularly to devices, non-transitory computer-readable media, and methods for providing user support during voice calls via generative artificial intelligence.

### BACKGROUND

Customer service is the support and assistance that a business offers to customers before, during, and after the customers buy or use the business's product or service. Customer service may include providing support for answering questions, troubleshooting, resolving complaints, offering product suggestions or advices, and other types of support. Over the years, the landscape of customer service has shifted from relying mostly on human representatives to provide support to relying largely on automated digital systems.

### SUMMARY

Devices, non-transitory computer-readable media, and methods for providing user support during voice calls via generative artificial intelligence are disclosed. An example method includes receiving, from a user endpoint device, a request to monitor an ongoing voice call between the user endpoint device and a second device for at least one task with which a generative artificial intelligence assistant is able to assist, monitoring the voice call in response to the request, detecting, based on the monitoring, a task to be performed on behalf of a user of the user endpoint device, executing the generative artificial intelligence assistant to generate an output in connection with the task, converting the output to an audio output using the generative artificial intelligence assistant, and delivering the audio output to the user endpoint device during the voice call.

In another example, a non-transitory computer-readable medium stores instructions which, when executed by a processing system including at least one processor, cause the processing system to perform operations. The operations include receiving, from a user endpoint device, a request to monitor an ongoing voice call between the user endpoint device and a second device for at least one task with which a generative artificial intelligence assistant is able to assist, monitoring the voice call in response to the request, detecting, based on the monitoring, a task to be performed on behalf of a user of the user endpoint device, executing the generative artificial intelligence assistant to generate an output in connection with the task, converting the output to an audio output using the generative artificial intelligence assistant, and delivering the audio output to the user endpoint device during the voice call.

In another example, a device includes a processing system including at least one processor and a non-transitory computer-readable medium. The non-transitory computer-readable medium stores instructions which, when executed by the processing system, cause the processing system to perform operations. The operations include receiving, from a user endpoint device, a request to monitor an ongoing voice call between the user endpoint device and a second device for at least one task with which a generative artificial intelligence assistant is able to assist, monitoring the voice call in response to the request, detecting, based on the monitoring, a task to be performed on behalf of a user of the user endpoint device, executing the generative artificial intelligence assistant to generate an output in connection with the task, converting the output to an audio output using the generative artificial intelligence assistant, and delivering the audio output to the user endpoint device during the voice call.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for providing user support during voice calls via generative artificial intelligence may operate;

FIG. 2 illustrates a flowchart of an example method for providing user support during voice calls via generative artificial intelligence, in accordance with the present disclosure;

FIG. 3 illustrates a flowchart of an example method for providing user support during voice calls via generative artificial intelligence, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for providing user support during voice calls via generative artificial intelligence. As discussed above, customer service is the support and assistance that a business offers to customers before, during, and after the customers buy or use the business's product or service. Customer service may include providing support for answering questions, troubleshooting, resolving complaints, offering product suggestions or advices, and other types of support. Over the years, the landscape of customer service has shifted from relying mostly on human representatives to provide support to relying largely on automated digital systems, such as interactive voice response (IVR) systems, chatbots, and the like.

The increased reliance on automated customer support systems has coincided with an increase in the volumes of calls to the customer support systems. This, in turn, has led to prolonged wait times for customers seeking support. These prolonged wait times have turned what should be a relatively straightforward process into a source of great frustration for customers, which fundamentally undermines customer satisfaction and loyalty.

Additionally, it is difficult for many customers to handle ancillary tasks (e.g., looking up relevant information, checking a calendar for availability, initiating a side task, or the like) without disrupting an ongoing customer support call. For instance, many call models require customers to pause the customer support call in order to address the ancillary task, which can lead to further inefficiencies and frustrations.

Examples of the present disclosure integrate generative artificial intelligence (GenAI) into a customer service framework to improve the efficiency of real-time customer support systems. In one example, a GenAI-powered assistant may interact with customers who are put on hold (i.e., waiting to speak to a human customer service representative), and the GenAI assistant may allow these customers to receive assistance without the need for direct human intervention. Access to the GenAI assistant may allow customers to complete simple tasks such as scheduling appointments, obtaining answers to questions, and other tasks in significantly less time than is currently possible.

Further examples of the present disclosure leverage edge computing to process customer support calls directly at the network edge, reducing latency and enabling seamless retrieval of information and performance of tasks in real time, without the need to pause the calls. This not only enhances productivity, but also improves the customer experience by providing swift, efficient, and multifaceted communication solutions.

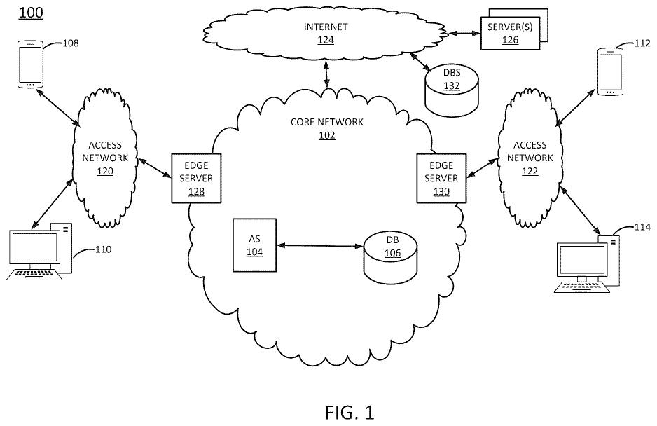

Examples of the present disclosure assume that the mobile networking landscape will evolve toward greater openness and fewer restrictions. With this assumption in mind, examples of the present disclosure provide several approaches that will enhance next generation customer support systems. In one example, a user participating in a voice call may activate a GenAI assistant system. The GenAI assistant system may perform operations at the network edge that may perform tasks on the user's behalf. The tasks may be inferred based on monitoring of the content of the voice call. If needed, audio output relating to the task may be generated as synthesized speech and delivered to the user as an overlay on the voice call. These and other aspects of the present disclosure are discussed in greater detail below in connection with the examples of FIGS. 1-4.

GenAI is a type of artificial intelligence that is capable of generating new text, images, videos, music, computer code, or other data using generative models, usually in response to prompts that specify some parameters for the data. GenAI models learn the patterns and structure of their input training data, and then generate new data that has similar characteristics to the input training data. Thus, GenAI can generate text, images, videos, music, computer code, or other data that did not exist previously, and that meets a set of user-specified criteria (e.g., source code in a specified program that performs a specified function).

Large language models (LLMs) are a key component of GenAI models, particularly for text generation. LLMs such as generative pre-trained transformers (GPTs) are trained on vast amounts of text data, which enables the LLMs to understand and generate human-like text based on the prompts received.

Within the context of LLMs, a “token” is understood to refer to the smallest unit of text that an LLM can understand and may be as small as a piece of a word (e.g., a syllable, a prefix, and suffix, etc.) or as large as a whole word or symbol. For instance, in the English language, the word “unbelievable” might be split into the parts “un,” “believe,” and “able” for processing by an LLM. Tokens are important, because tokens represent the input and output language of an LLM, affecting how the LLM interprets prompts and generates responses.

To use an LLM effectively, a user must typically interact with an interface or platform that allows the user to input prompts or parameters for a desired output. For GenAI, this might include describing the type of content (e.g., text, image, music, etc.) that the user wishes to have created. For an LLM, the user would likely provide a text prompt. The LLM would then process the input, using trained models and algorithms to generate content or responses that meet one or more of the user's criteria. The quality and relevance of the output can often be influenced by how specifically and clearly the user defines the request, which makes thoughtful prompt construction an important skill in leveraging GenAI and LLMs to their full potential.

Open networks are built on a foundation of openness and shared standards, which makes it easier for different technologies to talk to each other and work together seamlessly. An open network environment encourages new ideas and solutions to emerge, since anyone can contribute and improve upon existing technologies without the burden of legal restrictions to the need to navigate proprietary barriers. This openness not only foster innovation, but also ensures that technologies can easily connect and communicate, which is key for creating user-friendly systems.

Furthermore, open networks stimulate healthy competition among service providers, leading to better services and lower costs for consumers. Open networks offer users more choices and control over their digital experiences, allowing the users to select the best options for their needs. Additionally, the transparent nature of open networks means that a larger community of experts can examine and enhance security features, making open networks potentially more secure than closed networks. Moreover, by promoting accessibility, open networks help make technology available to a wider audience, contributing to a reduction in the digital divide. In a nutshell, open networks represent a collaborative and inclusive approach to technology that benefits all involves, from developers to end users.

Edge computing is a transformative technology that shifts data processing closer to the source of data generation, rather than relying on a centralized data processing warehouse. This approach is particularly significant in the contest of mobility networks and LLMs.

For mobility networks (which include technologies like autonomous vehicles, smart cities, and mobile devices), edge computing is crucial. Edge computing enables real-time data processing at the network's edge, where the data is generated. This immediacy is vital for applications requiring instant decision making, such as autonomous driving, where even a millisecond's delay can have major repercussions. By processing data locally, edge computing reduces latency, increases the speed of data analysis, and enhances the overall efficiency of mobile networks. This improves the user experience by making mobile services faster and more reliable, but also opens new possibilities for innovative mobile applications that require quick responses.

When it comes to LLMs like GPTs, edge computing offers several benefits. Firstly, by enabling data processing closer to the user, edge computing can significantly reduce the latency experienced by a user when interacting with AI models, making the user experience smoother and more interactive. This is especially important for applications that require real-time feedback based on LLM analysis, such as live language translation or interactive educational tools. Secondly, edge computing can help address privacy concerns by processing sensitive data locally, rather than sending this data across the network to a central server. Local processing means that data can be analyzed without necessarily leaving the device that generated the data or the local network, which adds an extra layer of security and privacy for users. Overall, edge computing represents a shift towards more efficient, responsive, and privacy-conscious computing, which makes edge computing an essential component of both mobility networks and the effective deployment of LLMs.

Speech-to-text (STT) technology, which may also be referred to as automatic speech recognition (ASR), converts spoken language into written text. ASR technology is crucial for a wide array of applications, including voice analysis systems (where ASR serves as the foundation for further analysis, such as sentiment analysis, voice authentication, and other types of analysis). By transcribing spoken words into text, ASR allows computers to process, understand, and respond to human speech, helping to bridge the gap between human communication and machine understanding.

In voice analysis systems, STT technology enables users to interact with technology in a natural and intuitive way, e.g., by using their voices rather than typing or clicking. This is particularly beneficial for accessibility, making technology more usable for individuals who have physical disabilities or are otherwise unable to type. Moreover, in environments where hands-free operation is essential (e.g., while driving or cooking), STT technology offers a safe and convenient way to interact with devices. STT technology also plays a significant role in data collection and analysis by allowing insights to be gathered from spoken interactions (which may be valuable in fields including customer service, healthcare, and others).

However, implementing STT technology comes with challenges, particularly in handling situations involving voice degradation. Voice degradation can occur due to various factors, including background noise, accents, dialects, or poor microphone quality, and can negatively affect the accuracy of speech recognition. Differentiating between similar sounding words or understanding heavily accented speech can be difficult for an STT system, and can lead to errors in transcription. These challenges necessitate continuous improvement and adaptation of STT algorithms, incorporation of advanced noise cancellation techniques, context understanding, and learning from diverse datasets to enhance accuracy and reliability under various conditions.

To further aid in understanding the present disclosure, FIG. 1 illustrates an example system 100 in which examples of the present disclosure for providing user support during voice calls via generative artificial intelligence may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks, such as access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise a Digital Subscriber Line (DSL) network, a public switched telephone network (PSTN) access network, a broadband cable access network, a Local Area Network (LAN), a wireless access network (e.g., an IEEE 802.11/Wi-Fi network and the like), a cellular access network, a 3^{rd} party network, and the like. For example, the operator of the core network 102 may provide a cable television service, an IPTV service, media streaming service, or any other types of communication services to subscribers via access network 120 or access network 122. In one example, the core network 102 may be operated by a telecommunication network service provider. The core network 102 and the access networks 120 and 122 may be operated by different service providers, the same service provider or a combination thereof, or the access networks 120 and 122 may be operated by an entity having a core business that is not related to telecommunications services, e.g., corporate, governmental, or educational institution LANs, and the like.

In one example, the access network 120 may be in communication with one or more user endpoint devices 108 and 110. The access network 120 may transmit and receive communications between the user endpoint devices 108 and 110, between the user endpoint devices 108 and 110 and the server(s) 126, the AS 104, other components of the core network 102, devices reachable via the Internet in general, and so forth. Similarly, the access network 122 may be in communication with one or more user endpoint devices 112 and 114. The access network 122 may transmit and receive communications between the user endpoint devices 112 and 114, between the user endpoint devices 112 and 114 and the server(s) 126, the AS 104, other components of the core network 102, devices reachable via the Internet in general, and so forth.

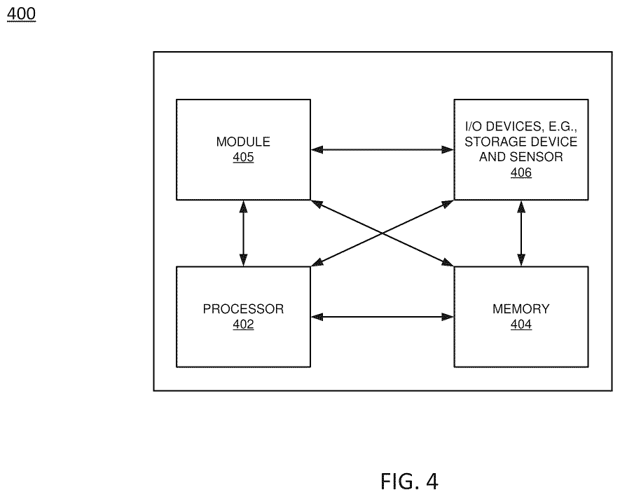

In one example, each of the user endpoint devices 108-114 may comprise any single device or combination of devices that a user may use to connect to a voice call. For example, any of the user endpoint devices 108-114 may comprise a mobile device, a cellular smart phone, a gaming console, an extended reality device, a set top box, a laptop computer, a tablet computer, a desktop computer, an Internet of Things (IoT) device, a wearable smart device (e.g., a smart watch, a fitness tracker, a head mounted display, or Internet-connected glasses), an autonomous vehicle (e.g., drone, self-driving automobile, etc.), or the like. To this end, the user endpoint devices 108-114 may comprise one or more physical devices, e.g., one or more computing systems or servers, such as computing system 400 depicted in FIG. 4, and may be configured as described below.

In one example, one or more servers 126 may be accessible to the user endpoint devices 108-114 via the Internet 124 in general. The server(s) 126 may operate in a manner similar to the AS 104.

In accordance with the present disclosure, the edge servers 128 and 130 may be configured to provide one or more operations or functions in connection with examples of the present disclosure for providing user support during voice calls via generative artificial intelligence, as described herein. For instance, the edge servers 128 and 130 may be configured to monitor voice calls between user endpoint devices 108-114 for utterances that indicate that a user requires the performance of a task (e.g., an information lookup, scheduling an appointment, language translation, or the like). The edge servers 128 and 130 may perform the task on behalf of the user and may provide audio output or feedback to the user during the voice call in a manner that allows the voice call to proceed without interruption.

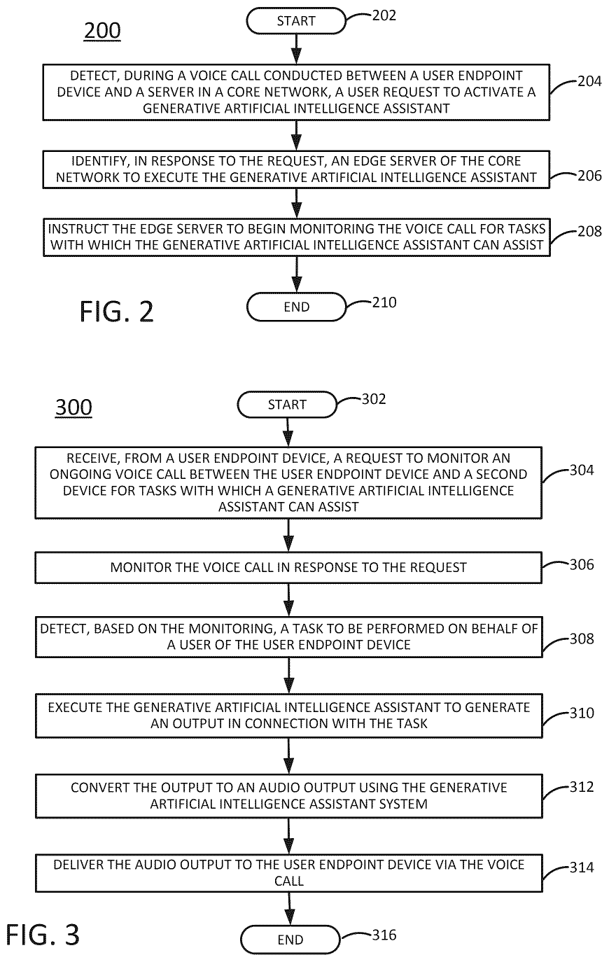

To this end, the edge servers 128 and 130 may comprise one or more physical devices, e.g., one or more computing systems or servers, such as computing system 400 depicted in FIG. 4, and may be configured as described below. In some examples, the edge servers 128 and 130 may comprise GenAI systems that may be integrated with other systems, including other AI systems. For instance, in one example, the edge servers 128 and 130 may load instructions into a memory, or one or more distributed memory units, and execute the instructions for providing user support during voice calls via generative artificial intelligence, as described herein. Example methods for providing user support during voice calls via generative artificial intelligence is described in greater detail below in connection with FIG. 2 and FIG. 3.

The AS 104 may have access to at least one database (DB) 106, where the DB 106 may store data that may be used by the edge servers 128 and 130 to perform tasks on a user's behalf. For instance, the AS 104 may support a calendar application, where the DB 106 may store information related to various users'calendars. In one example, DB 106 may comprise a physical storage device integrated with the AS 104 (e.g., a database server or a file server), or attached or coupled to the AS 104, in accordance with the present disclosure.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, media streaming server, a content distribution network (CDN) and the like. For example, portions of the core network 102, access networks 120 and 122, and/or Internet 124 may comprise a content distribution network (CDN) having ingest servers, edge servers, and the like. Similarly, although only two access networks 120 and 122 are shown, in other examples, the access networks 120 and 122 may comprise a plurality of different access networks that may interface with the core network 102 independently or in a chained manner. For example, user endpoint devices 108-114 may communicate with the core network 102 via different access networks. Thus, these and other modifications are all contemplated within the scope of the present disclosure.

FIG. 2 illustrates a flowchart of an example method 200 for providing user support during voice calls via generative artificial intelligence, in accordance with the present disclosure. In particular, FIG. 2 illustrates a method by which a user endpoint device connected to a voice call may invoke a generative artificial intelligence assistant. For instance, in one example, steps, functions and/or operations of the method 200 may be performed by a device as illustrated in FIG. 1, e.g., UE 108, 110, 112, or 114 or any one or more components thereof. In another example, the steps, functions, or operations of method 200 may be performed by a computing device or system 400, and/or a processing system 402 as described in connection with FIG. 4 below. For instance, the computing device 400 may represent at least a portion of the UE 108, 110, 112, or 114 in accordance with the present disclosure. For illustrative purposes, the method 200 is described in greater detail below in connection with an example performed by a processing system, such as processing system 402.

The method 200 begins in step 202 and proceeds to step 204. In step 204, the processing system may detect, during a voice call conducted between a user endpoint device and a second device, a user request to activate a generative artificial intelligence assistant.

In one example, the voice call may be a voice only call. However, in another example, the voice call may comprise a data and/or video component in addition to a voice component, such as may be the case in a video call. The user request may be provided in any one or more of a number of ways, including by a spoken command (e.g., the user speaking the instruction into a phone or other devices with a microphone, such as a tablet computer, a laptop computer, a headset, or the like), by entering a combination of letters and/or numbers on a keypad (e.g., the user entering the combination on a physical keyboard, a touchscreen keypad, or the like), or by opening a software application on a user endpoint device (e.g., the user launching an application associated with the generative artificial intelligence assistant system).

Where the request is provided by a spoken command, the processing system may use automatic speech recognition to extract a keyword from the spoken command that activates the GenAI assistant (e.g., causes the processing system to invoke the GenAI assistant). The keyword may comprise a predefined word or phrase that is known to the user.

Where the request is provided by entering a combination of letters and/or numbers on a keypad, the system may use character recognition or other techniques to extract a keyword that activates the GenAI assistant from the combination of letters and/or numbers. Alternatively, the combination of letters and/or numbers may comprise a predefined alphanumeric code that activates the GenAI assistant, where the code may not be a natural word. In a further example, rather than using character recognition to extract the code, the processing system may recognize the code by the dual-tone multifrequency (DTMF) tones associated with the combination of letters and/or numbers (e.g., each letter or number on the keypad may trigger the sounding of a slightly different DTMF tone).

Where the request is provided by opening a software application, the software application may be installed on the same user endpoint device as the device via which the user is engaging in the voice call. Opening the software application may be interpreted as receiving user permission for the software application to run in the background of the user endpoint device and to invoke the GenAI assistant. In another example, opening the software application may cause a dialog or other interactions to be initiated that seeks the user's explicit permission to invoke the GenAI assistant.

The user endpoint device may be a smart phone, a tablet computer, a laptop computer, a wearable smart device (e.g., a smart watch, smart glasses, or the like), or another type of device that includes a microphone. The second device may be another device of the same type as the user endpoint device, or a different type of device (e.g., an application server).

In step 206, the processing system may identify, in response to the request, an edge server of the core network to execute the generative artificial intelligence assistant. As discussed above, the processing system may be part of a user endpoint device or another device that is connected to the core network via an access network. For instance the processing system may be part of a smart phone, a tablet computer, or the like.

The core network may include a plurality of edge servers. Each of the edge servers may support the GenAI assistant and may perform operations related to performing tasks on the user's behalf. Each of the edge servers may also be physically located at different points around the edge of the core network. In step 206, the processing system may determine which of the plurality of edge servers is in the best location to handle the voice call. For instance, the processing system may identify an edge server that is located closest to a cellular base station (e.g., gNodeB) that is serving the user endpoint device during the voice call. This edge server is able to communicate with both the core network and the base station.

In step 208, the processing system may instruct the edge server to begin monitoring the voice call for tasks with which the generative artificial intelligence assistant can assist. In one example, the processing system may request that the edge server tap into the voice call from the core network, or run from inside the access network, if possible. For instance, the edge server may listen to the content of the voice call for keywords or other indications that the user needs to perform specific tasks, such as answer a question, check a calendar, schedule a meeting, or the like. As discussed in further detail below in connection with FIG. 3, the edge server may take actions to perform the specific tasks.

The method 200 may end in step 210. In one example, the method 200 may end when the processing system instructs the edge server to stop monitoring the voice call or otherwise indicates that the assistance of the GenAI assistant is no longer needed.

FIG. 3 illustrates a flowchart of an example method 300 for providing user support during voice calls via generative artificial intelligence, in accordance with the present disclosure. In particular, FIG. 3 illustrates a method by which a voice call may be transferred from a first server in a core network to an edge server of the core network, in response to a user activation of a generative artificial intelligence assistant system. For instance, in one example, steps, functions and/or operations of the method 300 may be performed by a device as illustrated in FIG. 1, e.g., AS 104 or any one or more components thereof. In another example, the steps, functions, or operations of method 300 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 300 is described in greater detail below in connection with an example performed by a processing system, such as processing system 402.

The method 300 begins in step 302 and proceeds to step 304. In step 304, the processing system may receive, from a user endpoint device, a request to monitor an ongoing voice call between the user endpoint device and a second device for tasks with which a generative artificial intelligence assistant can assist.

In one example, the user endpoint device may comprise a smart phone, a tablet computer, a wearable smart device (e.g., a smart watch, smart glasses, or the like), or another type of device that includes a microphone and that is connected to a core network via an access network. The second device may be another device of the same type as the user endpoint device, or a different type of device (e.g., an application server). The second device may connect to the core network via the access network or via another access network (or the Internet), or may reside in the core network.

The processing system may be part of an edge server that is located within the core network. The edge server may support a GenAI assistant system that infers tasks to be performed based on the detection of certain words, phrase, or events in the ongoing voice call and utilizes GenAI techniques to perform those tasks on behalf of a user of the user endpoint device.

In step 306, the processing system may monitor the voice call in response to the request. In one example, the processing system may use a network tap to monitor the voice call. In another example, the processing system may run an application inside the access network via which the user endpoint device connects to the core network. Monitoring the voice call may involve monitoring the utterances of the user of the user endpoint device and/or the utterances of the other party with whom the user is conversing (where the other party may be another person or an automated system, such as an interactive voice response system) and applying natural language understanding techniques to the utterances to detect when the utterances either directly or indirectly indicate the performance of a task.

In step 308, the processing system may detect, based on the monitoring, a task to be performed on behalf of a user of the user endpoint device. In one example, the task may be explicitly stated in an utterance. For instance, the user may be on hold with their doctor's office and may ask the processing system to monitor the status of the voice call and to make a doctor's appointment on the user's behalf once an operator in the doctor's office answers the voice call.

In another example, the task may be implied in an utterance. For instance, the user may be talking with another party who requests a meeting with the user and may further request the user's availability on a proposed date and/or at a proposed time. In this case, the processing system may infer that the user's availability on the specific date and/or at the specific time should be verified on the user's calendar.

In another example, the user may be talking with another party, and the processing system may detect that the other party has requested sensitive information (e.g., the user's social security information, financial information, password for a service, or the like). In this case, the processing system may infer that the user should be alerted to the fact that the voice call may be suspicious and should potentially be terminated.

In step 310, the processing system may execute the generative artificial intelligence assistant to generate an output in connection with the task. For instance, following the examples above, the processing system may interact with an operator in a doctor's office to schedule a doctor's appointment for the user. This may involve checking the user's calendar for availability, specifying a reason for the visit (e.g., well visit, illness or specific concern, etc.), synthesizing speech in order to interact with the operator to confirm scheduling, or the like. The output in this case may be a confirmation for the user of the date, time, and/or location of the scheduled doctor's appointment.

In the above meeting example, generating the output may involve checking the user's calendar for availability and confirming whether the user is available for a meeting at the proposed date and/or time (e.g., yes or no).

In the example where the other party may be requesting sensitive information, generating the output may involve identifying specific information that may be at risk, identifying a number from which the other party is calling, and/or generating an alert to warn the user.

In one example, the GenAI assistant may comprise a language model (e.g., a large language model (LLM), a small language model (SLM), or another type of language model), such as a generative pre-trained transformer (GPT).

In step 312, the processing system may convert the output to an audio output using the generative artificial intelligence assistant system. For instance, the output may initially exist in a text-based form (e.g., “Yes, you are available to meet at the proposed time;” “No, you are not available to meet at the proposed time;” “You have an appointment with Dr. Smith scheduled for December 1 at 12:00 PM;” “This call may be suspicious and you should consider hanging up;” etc.). The processing system may use one or more text-to-speech techniques to convert this text to an audio output, such as a synthesized speech output.

In step 314, the processing system may deliver the audio output to the user endpoint device during the voice call. In one example, delivering the audio output may involve appending the audio output to the voice call in a manner that makes the audio output audible to the user, but not to the other party. The method 300 may end in step 316.

It should be noted that the method 200 and the method 300 may be expanded to include additional steps or may be modified to include additional operations, parameters, or scores with respect to the steps outlined above. In addition, although not specifically specified, one or more steps, functions, or operations of the method 200 or the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

The ability to monitor the voice call and perform GenAI-related tasks at the network edge allows examples of the present disclosure to perform tasks on the user's behalf more quickly than if these operations were performed at another location within the core network. This may minimize the amount of time that a user needs to spend on a voice call (e.g., interacting with an interactive voice response system or a human operator, waiting on hold, or the like) by providing relevant or needed information without disrupting the flow of the call. The disclosed approach may also provide greater protection for any sensitive data that may be transmitted in connection with the voice call. Additionally, by embedding these capabilities at the Internet service provider level, a consistent and high-quality experience can be ensured for all users across the network, which fosters a more connected and efficient digital environment.

Moreover, although examples of the present disclosure discuss assisting a user by delivering audio output that is only audible to the user, in some examples it may be beneficial to deliver the audio output to the other party (or to both the user and the other party). As an example, the user may be conducting the voice call while traveling (e.g., driving, on a train, or the like), and the GenAI assistant may detect that the user is about to enter a physical location where the RAN signal strength is weak and the call may be dropped (or suffer from poor audio quality). In this case, the GenAI assistant may generate an audio output to be delivered to the other party to warn them that the user is entering a location with low signal strength and that the call may be dropped. In further examples, the GenAI assistant may have knowledge of the user's trajectory (e.g., from a navigation system, a train schedule, or the like), and may be able to estimate when the user will exit the location having the low signal strength. In this case, the GenAI assistant may instruct the other party to call back at a certain time at which the user is estimated to be in a location with better signal strength (e.g., “Please try calling back in ten minutes”).

The types of assistance that the GenAI assistant may provide are varied. For instance, examples of the GenAI assistant may perform question assistance, i.e., understanding and responding to various user inquiries and providing accurate and relevant information quickly. Other examples of the GenAI assistant may perform translation services, i.e., facilitating seamless communication between users who speak different languages by translating conversations in real time. Other examples of the GenAI assistant may perform auto-reply services, i.e., generating automatic responses for common queries to ensure that users receive prompt replies, even during times of high call volumes or when human agents are unavailable.

The GenAI assistant may also prove useful in a variety of fields. For instance, in customer service fields, a user may interact with the GenAI assistant to resolve common issues, schedule service appointments, or obtain information about their accounts, thereby reducing wait times and improving user satisfaction. In multilingual support fields, the GenAI assistant may provide real-time translation capabilities to ensure that businesses can serve a diverse customer base without language barriers, fostering inclusivity and better communication. In task automation fields, the GenAI assistant may seamlessly handle routine tasks, such as bill payment and scheduling callbacks, during a voice call. This enhances convenience and efficiency for users.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for providing user support during voice calls via generative artificial intelligence, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 or method 300 as discussed above is implemented in a distributed or parallel manner for a particular illustrative example, i.e., the steps of the above method 200 or method 300 or the entire method 200 or method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200 or method 300. In one example, instructions and data for the present module or process 405 for providing user support during voice calls via generative artificial intelligence (e.g., a software program comprising computer-executable instructions) can be loaded into memory 404 and executed by hardware processor element 402 to implement the steps, functions, or operations as discussed above in connection with the illustrative method 200 or method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for providing user support during voice calls via generative artificial intelligence (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor, from a user endpoint device, a request to monitor an ongoing voice call between the user endpoint device and a second device for at least one task with which a generative artificial intelligence assistant is able to assist;
monitoring, by the processing system, the voice call in response to the request;
detecting, by the processing system based on the monitoring, a task to be performed on behalf of a user of the user endpoint device;
executing, by the processing system, the generative artificial intelligence assistant to generate an output in connection with the task;
converting, by the processing system, the output to an audio output using the generative artificial intelligence assistant; and
delivering, by the processing system, the audio output to the user endpoint device during the voice call.

2. The method of claim 1, wherein the processing system is part of an edge server that is located within a core network.

3. The method of claim 2, wherein the user endpoint device is connected to the core network via an access network.

4. The method of claim 3, wherein the monitoring is performed by running an application inside the access network.

5. The method of claim 1, wherein the monitoring comprises using a network tap to monitor the voice call.

6. The method of claim 1, wherein the monitoring comprises monitoring utterances of the user of the user endpoint device and applying a natural language understanding technique to the utterances to detect when the utterances indicate a performance of the task.

7. The method of claim 6, wherein the task is explicitly stated in the utterances.

8. The method of claim 6, wherein the task is inferred from the utterances.

9. The method of claim 1, wherein the executing includes interacting with a data source.

10. The method of claim 1, wherein the executing includes interacting with an automated system.

11. The method of claim 1, wherein the executing includes interacting with a human operator.

12. The method of claim 1, wherein the generative artificial intelligence assistant comprise at least one of: a large language model or a small language model.

13. The method of claim 1, wherein the output exists in a text-based form prior to the converting.

14. The method of claim 13, wherein the converting comprises applying a text-to-speech technique to the output in the text-based form.

15. The method of claim 14, wherein the audio output comprises synthesized speech.

16. The method of claim 1, wherein the delivering comprises appending the audio output to the voice call in a manner that makes the audio output audible to the user, but not to a second party to the voice call.

17. The method of claim 1, wherein the delivering comprises appending the audio output to the voice call in a manner that makes the audio output audible to the user and to a second party to the voice call.

18. The method of claim 1, wherein the delivering comprises appending the audio output to the voice call in a manner that makes the audio output audible to a second party to the voice call, but not to the user.

19. A non-transitory computer-readable medium storing instructions which, when executed by a processing system including at least one processor, cause the processing system to perform operations, the operations comprising:
receiving, from a user endpoint device, a request to monitor an ongoing voice call between the user endpoint device and a second device for at least one task with which a generative artificial intelligence assistant is able to assist;
monitoring the voice call in response to the request;
detecting, based on the monitoring, a task to be performed on behalf of a user of the user endpoint device;
executing the generative artificial intelligence assistant to generate an output in connection with the task;
converting the output to an audio output using the generative artificial intelligence assistant; and
delivering the audio output to the user endpoint device during the voice call.

20. A device comprising:
a processing system including at least one processor; and
a non-transitory computer-readable medium storing instructions which, when executed by the processing system, cause the processing system to perform operations, the operations comprising:
receiving, from a user endpoint device, a request to monitor an ongoing voice call between the user endpoint device and a second device for at least one task with which a generative artificial intelligence assistant is able to assist;
monitoring the voice call in response to the request;
detecting, based on the monitoring, a task to be performed on behalf of a user of the user endpoint device;
executing the generative artificial intelligence assistant to generate an output in connection with the task;
converting the output to an audio output using the generative artificial intelligence assistant; and
delivering the audio output to the user endpoint device during the voice call.
